(19) United States
(12) Patent Application Publication
(10) Pub. No.: US 2013/0143185 A1
(43) Pub. Date: Jun. 6, 2013

(54) DETERMINING USER EMOTIONAL STATE

(71) Applicants: Eric Liu, Santa Clara, CA (US); Stefan J. Marti, Santa Clara, CA (US)

(72) Inventors: Eric Liu, Santa Clara, CA (US); Stefan J. Marti, Santa Clara, CA (US)

(21) Appl. No.: 13/310,104

(22) Filed: Dec. 2, 2011

(51) Int. Cl. G09B 19/00

(52) U.S. Cl. 434/236

(57) ABSTRACT

An emotional state of a user of a computing device may be determined. For example, the user's emotional state may be determined based on a predicted or expected impact of a content item or object on the user's emotional state.

### BACKGROUND

Computing devices are becoming prevalent in everyday life. Some people spend large periods of time using computing devices, whether for work, school, or recreation. Sometimes people may spend more time interacting with their computing devices than with other people. Manufacturers of computing devices are challenged with providing positive user experiences so that users enjoy using their computing devices.

### BRIEF DESCRIPTION OF DRAWINGS

The following detailed description refers to the drawings, wherein:

FIG. 1 is a block diagram illustrating a computing device for determining an emotional state of a user, according to an example.

FIG. 2 is a block diagram illustrating a computing device for determining an emotional state of a user, according to an example.

FIG. 3 is a flowchart illustrating aspects of a process for determining an emotional state of a user, according to an example.

FIG. 4 is a flowchart illustrating aspects of a process for tracking an emotional state of a user, according to an example.

FIG. 5 is a flowchart illustrating aspects of a process for processing a new object, according to an example.

FIG. 6 is a flowchart illustrating aspects of a process for determining an emotional tag of a new object, according to an example.

FIG. 7 is a block diagram illustrating a computer including a machine-readable storage medium encoded with instructions for determining an emotional state of a user, according to an example.

### DETAILED DESCRIPTION

Manufacturers of computing devices are challenged with providing positive user experiences so that users enjoy using their computing devices. As described in detail below, various example embodiments relate to techniques of determining, modifying, and/or tracking a user's emotional state. In addition, various example embodiments relate to techniques of reacting to and influencing the user's emotional state through the presentation of media, other content items, and the like. As a result, a more positive user experience may be achieved.

In particular, an emotionally intelligent computing device that can adjust to the emotional state of a user is desirable. Whereas people can often determine the emotional state of a colleague or friend and adjust their actions accordingly, computers generally cannot determine a user's emotional state and after its actions in light of that emotional state. For instance, after a person has received had news, a friend of that person likely would not bring up more bad news. On the other hand, after a user has read an email containing bad news, a computer may proceed to deliver more bad news to the user, such as a depressing news story received via a news feed, for example. By monitoring a user's emotional state, however, a computer may recognize when it may be inopportune to present certain content to the user. Moreover, the computer may engage in actions to influence the user's emotional state in a positive way. A more positive user experience may thus be achieved. A user may even come to appreciate his computer for being emotionally sensitive, much as a person may appreciate a close friend.

According to various example embodiments, an emotional state of the user may be predicted in many ways. For example, a computer may track incoming content items, such as emails and news stories, and evaluate the content items for predicted impact on the emotional state of the user. A continuous emotional state of the user may thus be tracked and modified based on the predicted impact of incoming content items. In some embodiments, the tracked emotional state may be initialized and/or further modified based on a reading from a biometric sensor, such as a heart rate monitor, a galvanic skin response monitor, a voice tone analyzer, or a pupil movement tracker.

In addition, a computer may use the tracked emotional state in various ways. For instance, a computer may compare the emotional state to a range of values to determine an appropriate action. The computer may refrain from presenting certain content items to the user if the content items are predicted to have a negative effect on an already negative emotional state. In some embodiments, only time insensitive items are withheld from a user, while time sensitive items are always presented to a user irrespective of the tracked emotional state. The computer may also select certain content items to be presented to the user based on a positive effect that the content item is predicted to have on the emotional state. In some cases, the presented content item may be a soundtrack or background color or scene already stored on the computer. A predicted impact of the newly presented content items may also be used to modify the tracked emotional state. In this way, a computer may assist in helping to maintain a stable and balanced emotional state for its user.

Further details of these embodiments and associated advantages, as well as of other embodiments and applications, will be discussed in more detail below with reference to the drawings.

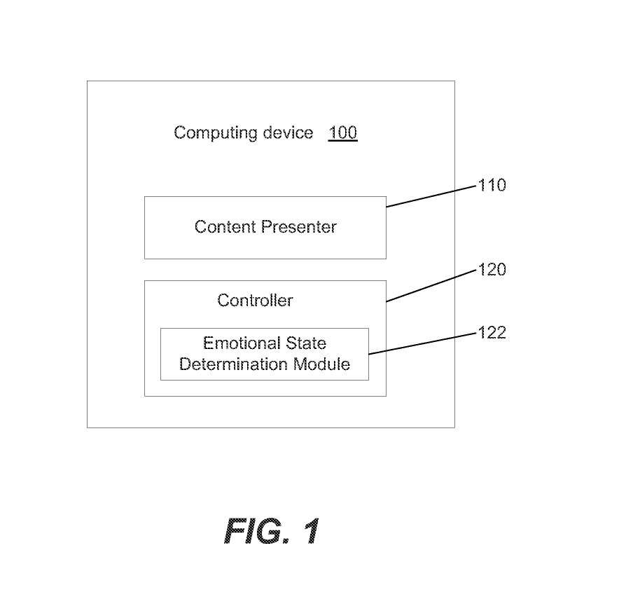

Referring now to the drawings, FIG. 1 is a block diagram illustrating a computing device 100, according to an embodiment. Computing device 100 may be any of a variety of computing devices. For example, computing device 100 may be a cellular telephone, a smart phone, a media player, a tablet or slate computer, a laptop computer, or a desktop computer, among others.

Computing device 100 may include a content presenter 110. Content presenter 110 may present a content item to a user of the computing device. For example, content presenter 110 may include a display and/or a speaker. A display can provide visual content to a user, such as text, pictures, and video. A speaker can provide aural content to a user, such as voice, songs, and other sounds. Content presenter 110 may also include other devices or components for presenting content to a user, as further described below. Additionally, content presenter 110 may include drivers and application programs for facilitating presentation of content to a user.

Computing device 100 may include a controller 120 having an emotional state determination module 122. Controller 120 may include a processor and a memory for implementing emotional state determination module 122. The processor may include at least one central processing unit (CPU), at least one semiconductor-based microprocessor, at least one digital signal processor (DSP) such as a digital image processing unit, other hardware devices or processing elements suitable to retrieve and execute instructions stored in memory, or combinations thereof. The processor can include single or multiple cores on a chip, multiple cores across multiple chips, multiple cores across multiple devices, or combinations thereof. The processor may fetch, decode, and execute instructions from memory to perform various functions, such as generating, processing, and transmitting image data. As an alternative or in addition to retrieving and executing instructions, the processor may include at least one integrated circuit (IC), other control logic, other electronic circuits, or combinations thereof that include a number of electronic components for performing various tasks or functions.

Controller 120 may include memory, such as a machine-readable storage medium. The machine-readable storage medium may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium can be computer-readable and non-transitory.

In an embodiment, content presenter 110 may present content items to a user of computing device 100. A content item may be any of various items that convey some form of content. For example, a content item can be a media item. Example media items are a news article, a document, an image, a video, a song, a color, and a sound. A content item can be a communication. Example communications are an email, a text message, an instant message, a phone call, a voice mail, a video call, a video message, and a tweet. A content item can be an event. Example events are a calendar reminder, a task reminder, and an error message (e.g., from the computer operating system or an application program).

A content item may include other things that may stimulate the senses of a human being. For example, a content item may be a touch stimulus, such as pressure or an electric shock, a smell stimulus, such as a fragrance, or a taste stimulus. Other content items may exist as well. In addition, content items are also referred to below as objects.

Content presenter 110 may present the content item to the user in any suitable way. For example, the content item may be presented to the user via a device capable of presenting the particular content item to the user. For instance, the content may be presented via a display, a speaker, a massager, a fragrance emitter, a keyboard or touchpad (e.g., via tactile feedback), a robot, or the like.

Controller 120 may determine a current emotional state of the user based on a predicted emotional impact of each of the presented content items. For example, controller 120 may make this determination using emotional state determination module 122.

The emotional state of a person can be a complex phenomenon. Emotion may be a psycho-physiological experience and may be influenced by internal biochemical and external environmental conditions. Emotion can be associated with personality, mood, temperament, disposition, and motivation of an individual. The emotional state of a person may be considered an overall snapshot or view of a person's emotions at a point in time. Because so many factors go into a person's emotional state, the emotional state may fluctuate even over short periods of time. By looking at external environmental conditions, a person's emotional state may be predicted. Moreover, changes to a person's emotional state may be predicted based on new or changing environmental conditions.

A content item may involve or relate to one or more concepts. As examples, a concept may be birth, death, or a deadline. Various feelings and emotions may be associated with a concept. An affective meaning model may be used to evaluate a concept. In particular, every concept may have an affective meaning, or connotation, which varies along one or more dimensions.

For example, a given concept may have a connotation that varies along three dimensions: evaluation, potency, and activity. A given concept's evaluation may vary between goodness and badness. A concept's potency may vary between powerfulness and powerlessness. A concept's activity may vary between liveliness and torpidity. By determining the concepts associated with a given content item and measuring each concept based on these dimensions; a predicted affective meaning of the content item may be determined. From this affective meaning, a predicted emotional impact of the content item may be determined.

As another example, a given concept may have an affective meaning or connotation which varies along two dimensions: arousal and valence. A concept's arousal may vary between calming or soothing and exciting or agitating. A concept's valence may vary between highly positive and highly negative. A predicted emotional impact of a content item may similarly be determined using this affective meaning model. In some embodiments, the affective meaning of a concept may be determined based on a single dimension, such as valence—highly positive versus highly negative.

Even if a multi-dimensional affective meaning model is used, the ultimate predicted emotional impact of a content item may still be represented along a single dimension. Similarly, the user's emotional state may also be represented along the same single dimension. Where multiple dimensions are used to represent the affective meaning of concepts related to the content item, the multiple dimensions may be reduced to a single dimension through dimension reduction, such as feature extraction.

In some embodiments, the values for the multiple dimensions can simply be averaged to achieve a single dimension. In such a case, each dimension could be evaluated to determine a general likely impact that the particular dimension would have on the user's emotional state, such as positive vs. negative, or happy vs. depressed. Thus, for example, in the three-dimension affective meaning model described above, the dimension of evaluation could be evaluated as positive for goodness and as negative for badness. Similarly, the dimension of potency could be evaluated as positive for powerfulness and negative for powerlessness and the dimension of activity could be evaluated as positive for liveliness and negative for torpidity. Accordingly, an average score along the general scale of positive vs. negative could be determined for this three-dimension affective meaning model. The predicted emotional impact of a content item, and an overall emotional state of a user, may thus be represented along the scale of positive vs. negative.

For ease of explanation, the emotional state is described in the example embodiments below as measured along a single dimension. Of course, a multi-dimensional emotional state may be easily implemented through the use of a data structure, object, or the like, having multiple variables to represent the multiple dimensions of the emotional state.

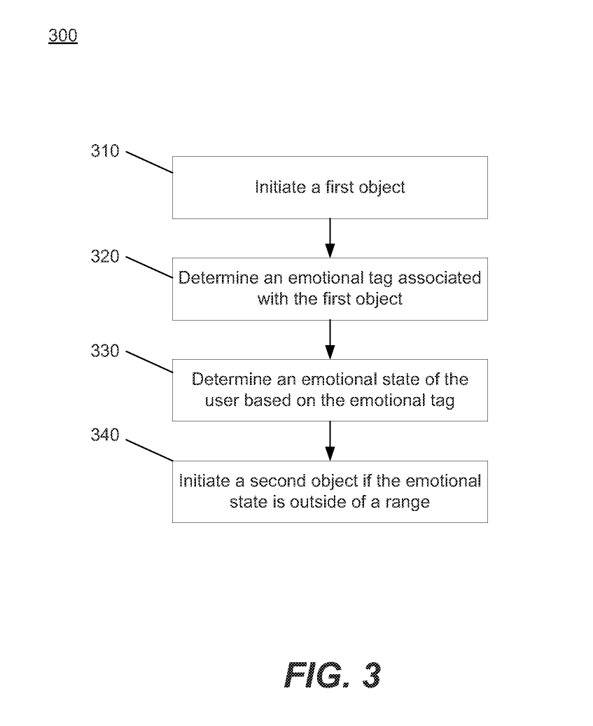

Emotional state determination module 122 may determine an emotional state of the user based on predicted emotional impact of content items that are presented to the user, as described above. Example processing that can be implemented by emotional state determination module 122 is described in further detail below with reference to FIGS. 3-6.

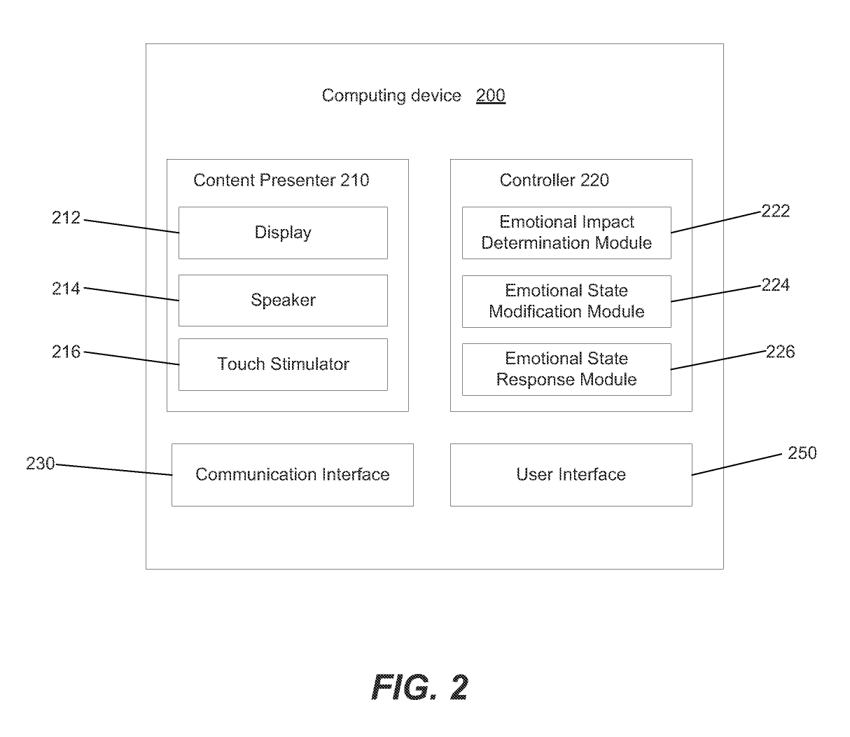

FIG. 2 is a block diagram illustrating an example of a computing device 200 including a content presenter 210 and a controller 220, similar to computing device 100, but with additional detail and modification. Computing device 200 can also include a communication interface 230 and a user interface 240.

Content presenter 210 can include a display 212, a speaker 214, and a touch stimulator 216. Display 212 can present visual content, speaker 214 can present aural content, and touch stimulator 216 can provide touch content. These devices can be integrated into computing device 200 (e.g., an integrated display on a touchpad computer), physically connected thereto (e.g., headphones connected to an auxiliary port on a touchpad computer), or remotely connected thereto (e.g., a Wi-Fi or Bluetooth enabled printer). For instance, touch stimulator 216 may be a massager attached to a chair of a user of computing device 200. Content presenter 210 may include other devices or components as well, such as a fragrance emitter, a keyboard, a touchpad, a robot, or the like. Content presenter 210 can include any device capable of presenting a content item to a user.

Communication interface 230 may be used to connect to and communicate with multiple devices. Communication interface may include, for example, a transmitter that may convert electronic signals to radio frequency (RF) signals and/or a receiver that may convert RF signals to electronic signals. Alternatively, communication interface 230 may include a transceiver to perform functions of both the transmitter and receiver. Communication interface 230 may further include or connect to an antenna assembly to transmit and receive the RF signals over the air. Communication interface 230 may communicate with a network, such as a wireless network, a cellular network, a local area network, a wide area network, a telephone network, an intranet, the Internet, or a combination thereof. Communication interface 230 may also include an Ethernet connection, a USB connection, or other direct connection to a network or other devices.

Controller 220 can determine the predicted emotional impact of a presented content item. For example, controller 220 can include an emotional impact determination module 222 to make this determination.

Emotional impact determination module 222 can determine a predicted emotional impact of a presented content item based on a keyword associated with the presented content item. For instance, if the content item is an email, emotional impact determination module 222 can parse the words in the email and compare the parsed words to keywords stored in a database. The stored keywords can be stored in association with an affective meaning, represented by scores along one or more dimensions. The stored keywords and associated affective meaning can be part of a preexisting database stored on the computer for purposes of emotional impact determination. In some embodiments, the database could be stored remotely and be accessed via the Internet, for example. A predicted emotional impact of the email can be determined based on the scores associated with the keywords found in the email. In one embodiment, the scores of all of the keywords can be averaged to determine the overall predicted emotional impact of the entire email. Emotional impact determination module 222 can thus determine a predicted emotional impact of the email based on keywords.

Emotional impact determination module 222 can also determine a predicted emotional impact of a presented content item based on a person associated with the presented content item. The person associated with the presented content item could be a keyword with an associated affective meaning, as described above. For example, the person could be a famous person such as Mohandas Ghandi or Michael Jordan. Alternatively, the person could be a contact of the user of computing device 200. In such a case, an affective meaning may still be associated with the contact. For example, over time, computing device 200 can develop an affective meaning score for the particular contact based on the affective meaning of the content items that the particular contact is associated with. If the contact is always the author of emails with inflammatory language, for instance, the contact may have a negative affective meaning. This information can be stored in the same database as the keywords, such that the contact becomes another keyword. Alternatively, there can be a separate database specifically for storing contacts and associated affective meanings. Emotional impact determination module 222 can thus determine a predicted emotional impact of a content item based on a person associated with the content item.

Example processing that can be implemented by emotional impact determination module 222 is described in further detail below with reference to FIGS. 3-6.

Controller 220 can determine the current emotional state of a user. For example, controller 220 can include an emotional state modification module 224 to make this determination. Emotional state modification module. 224 can determine the current emotional state of a user by modifying a tracked emotional state of the user based on the predicted emotional impact of each presented content item. Prior to modification, the tracked emotional state of the user can represent a predicted emotional state of the user up to the point prior to presentation of the most recently presented content item.

For example, at the beginning of a computing session between a user and computing device 200, a tracked emotional state of the user may be initiated. The tracked emotional state may be initiated in various ways. For instance, the tracked emotional state may be initiated at an average value representing a stable emotional state. Alternatively, the tracked emotional state can be initiated based on responses from the user to one or more questions presented to the user inquiring into his current emotional state. In addition or alternatively, the initial emotional state of the user may be determined based on readings from one or more biometric sensors, such as a heart rate monitor, a galvanic skin response monitor, a voice tone analyzer, and a pupil movement tracker. The initial emotional state may also be determined by taking other environmental conditions into consideration, such as the time of day, stock market trends, the weather forecast, and the current season. A user profile, such as an emotional profile of the user, may also be accessed to determine an initial emotional state. A combination of these techniques may also be used.

After initialization of the tracked emotional state, the tracked emotional state may be modified based on the predicted emotional impact of presented content items. Accordingly, for example, if a user opens an email inbox, the predicted emotional impact of emails viewed by the user can be determined, much as described above, and the tracked emotional state can be modified based on the predicted emotional impact of each email. Other content presented to the user can be similarly evaluated and the tracked emotional state can be modified accordingly. The current emotional state can be equal to the tracked emotional stare after all presented content items have been evaluated and the associated emotional impact has been factored in to the tracked emotional state. Alternatively, in some embodiments, the current emotional state can be the current value of the tracked emotional state, whether or not there are additional presented content items that need to be evaluated.

Example processing that can be implemented by emotional state modification module 224 is described in further detail below with reference to FIGS. 3-6.

Controller 220 can select a balancing content item if the current emotional state is outside a range and can cause content presenter 210 to present the selected balancing content item to the user. Controller 220 can include an emotional state response module 226 to achieve this functionality. A balancing content item may be considered to be a content item having a predicted emotional impact that will cause the tracked emotional state of the user to move closer to the range.

Controller 220 can compare the current emotional stare to a range. The range can represent an emotional state that computing device 200 is attempting to maintain for the user. In some embodiments, the range can represent a stable, content emotional state. For example, for a one-dimensional, linearly-represented emotional state, a stable range may be represented as between the values 5 and 15. Thus, if the emotional state falls below 5 or exceeds 15, it can be assumed that the emotional state of the user is unstable or not content. If the emotional state is below 5, that may signify that the emotional state of the user is approaching depressed. If the emotional state is above 15, that may signify that the emotional state of the user is approaching overly stimulated. The underlying reasons for the abnormal emotional state may vary. For example, a lower emotional state may be due to the user having received bad news, having read a depressing story, or having received notice of an impending work deadline that the user feels he cannot meet. A higher emotional state may be due to the user having received good news, having read an exciting story, or having received notice of extension of an impending deadline.

In any case, if the current emotional state of the user is outside the range, emotional state response module 226 may select a balancing content item and may cause content presenter 210 to present the selected balancing content item to the user. This action can be taken to attempt to bring the user's emotional state back into the desired range. Accordingly, emotional state response module 226 may select the balancing content item based on a predicted emotional impact of the content item. For example, the emotional state response module 226 may access a database where content items are stored in association with their affective meaning or predicted emotional impact. The emotional state response module 226 may determine whether the predicted emotional impact associated with a particular content item will cause the user's current emotional state to move closer to the desired range. Thus, the emotional state response module may in a sense look ahead and determine what the impact on the user's emotional state will be if the content item is presented to the user and its associated predicted emotional impact is used to modify the tracked emotional state by the emotional state modification module 224. If the predicted emotional impact of the particular content item will cause the tracked emotional state to move closer to the range, then the content item may be selected as a balancing content item.

Emotional state response module 226 may then cause content presenter 210 to present the selected balancing content item to the user. In some embodiments, the user may choose whether to allow presentation of the balancing content item. If presented, the balancing content item may be processed by controller 220 similar to other presented content items and the tracked emotional state may be modified accordingly. In some embodiments, emotional state response module 226 may select and cause to present more than one balancing content item. For example, emotional state response module 226 may organize a sequence of balancing content items intended to have a certain effect on the user's emotional state. For instance, to combat a negative emotional state the sequence may include a change in desktop background color to a more soothing color, presentation of a soundtrack with calming sounds, and presentation of a peace-inducing news article or story. The predicted emotional impact of each content item may then be used to modify the tracked emotional state of the user.

Example processing that can be implemented by emotional state response module 226 is described in further detail below with reference to FIGS. 3-6.

Computing device 200 can include a user interface 240. User interface 240 may be a graphical user interface, a voice command interface, one or more buttons, or any other interface that can permit the user to interact with computing device 200. Furthermore, user interface 240 may include multiple interfaces or a combination of different interfaces.

User interface 240 may include a first user interface to receive from the user a response to a question regarding a current emotional state of the user. For example, at the beginning of a computing session between a user and computing device 200, computing device 200 may initiate a tracked emotional state of the user. To ensure that the tracked emotional state starts out at a value close to the user's actual emotional state, computing device 200 can ask the user one or more questions via the first interface to determine the user's current emotional state. For example, the first user interface can ask the user to indicate his current emotional state by entering text into a text box, by selecting one of several emotional states presented to the user via radio buttons, by verbally indicating his emotional state, or the like. In some examples, the user may request that computing device 200 present a more in-depth questionnaire so that his current emotional state can be more accurately determined. In addition, computing device 200 may verify a current emotional state of the user anytime during a computing session. This can be helpful to prevent errors in tracked emotional state from building upon themselves in a phenomenon known as drift. Of course, if computing device 200 interrupts the user too many times to verify the user's emotional state, the user may become agitated. Emotional state modification module 224 may modify the tracked emotional state based on the user's responses via the first user interface.

User interface 240 may include a second user interface to receive a response from the user indicating acceptance or rejection of a balancing content item that has been suggested or presented to the user by emotional state response module 226. For instance, the second user interface can ask the user if he would like to have the balancing content item presented to him. Alternatively, the balancing content item can be presented to the user and the user can then indicate that he does not want the balancing content item. For example, if the balancing content item were a song, computing device 200 could begin playing the song over speaker 214. The user could then stop the song from playing via the second user interface. Computing device 200 can use the user's response to the balancing content item to verify and/or correct the tracked emotional state. For example, a user's rejection of a balancing content item could signify that the user's actual emotional state is not the same as the tracked emotional state. Thus, emotional state modification module 224 may modify the tracked emotional state based on the user's response via the second user interface.

FIG. 3 is a flowchart illustrating aspects of a method 300 that can be executed by a computing device for tracking an emotional state of a user, according to an example. Although execution of method 300 is described below with reference to the components of computing device 200, other suitable components for execution of method 300 can be used, such as components of computing device 100 or computer 700. Method 300 may be implemented in the form of executable instructions stored on a machine-readable medium or in the form of electronic circuitry. A processor, a machine-readable storage medium, other control logic, or a combination thereof can be used to execute method 300.

Method 300 may start at 310 where a first object is initiated. An object can be a content item, as described above. Computing device 200 can initiate the first object by presenting it to the user. The first object can be presented to the user in any suitable way. For example, computing device 200 can present the first object to the user via content presenter 210.

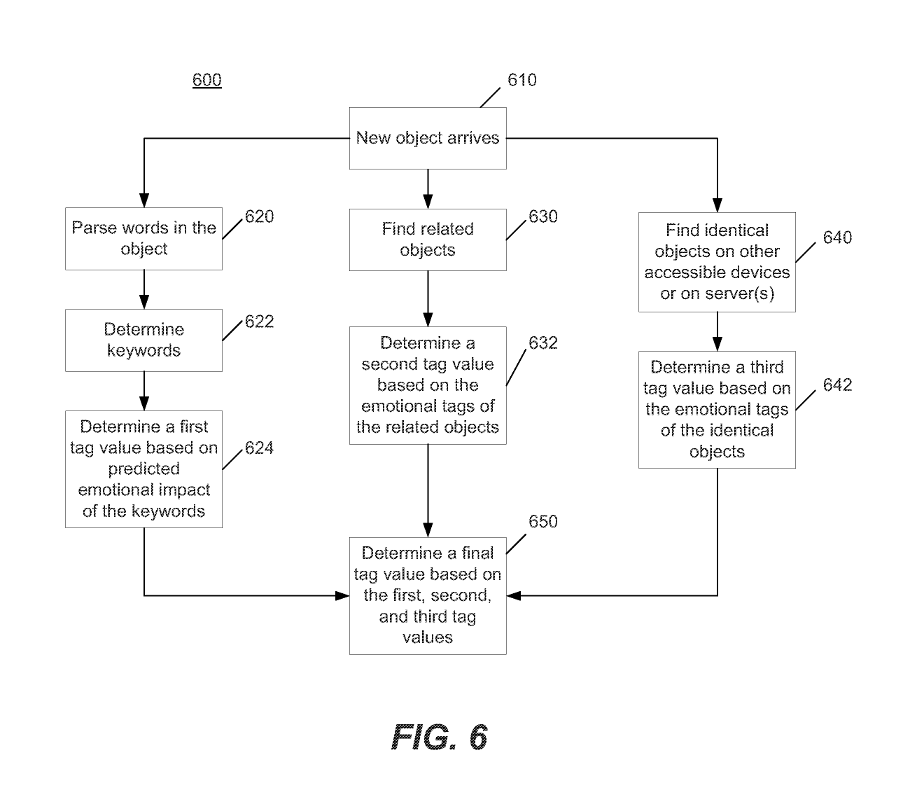

Method 300 may proceed to 320 where an emotional tag associated with the first object may be determined. The emotional tag can indicate a predicted emotional impact of the first object on the user. Computing device 200 can determine the emotional tag using emotional impact determination module 222 of controller 220. Emotional tags are described in further detail below with reference to FIG. 6.

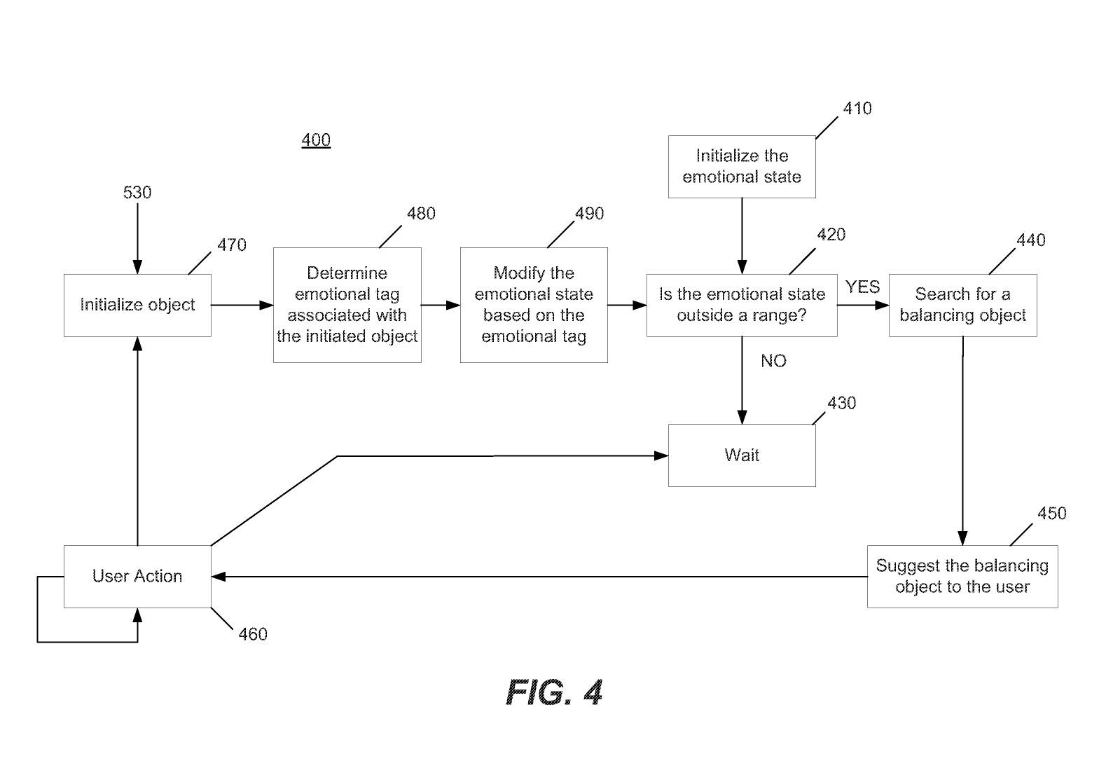

At 330, an emotional state of the user may be determined based on the emotional tag associated with the first object. The emotional state of the user may be a predicted emotional state of the user. An emotional state of the user can be predicted based on a predicted emotional impact of initiated objects. An emotional state of the user may already be being tracked (e.g., based on already initiated objects) and thus the tracked emotional state can be determined by modifying the emotional state based on the emotional tag associated with the first object, which indicates the object's predicted emotional impact. Computing device 200 can determine the emotional state of the user based on the emotional tag associated with the first object using emotional state modification module 224 of controller 220. Tracking a user's emotional state is described in further detail below with reference to FIG. 4.

At 340, a second object can be initiated if the emotional state is outside of a range. Computing device 200 can initiate the second object using emotional state response module 226 and content presenter 210. The range can represent an emotional state that method 300 is attempting to maintain for the user. For example, the range may represent a stable, content emotional state. Thus, if the user's emotional state is outside of the range, method 300 can take an action to attempt to cause the user's emotional state to move back into the range. Accordingly, the second object can be initiated in an attempt to bring the user's emotional state back within the desired range. The second object can be initiated based on it having an associated emotional tag that causes the emotional state of the user to move closer to the range. The tracked emotional state of the user may then be modified based on an emotional tag associated with the second object.

FIG. 4 is a flowchart illustrating aspects of a method 400 that can be executed by a computing device for tracking an emotional state of a user, according to an example. Although execution of method 400 is described below with reference to the components of computing device 200, other suitable components for execution of method 400 can be used, such as components of computing device 100 or computer 700. Method 400 may be implemented in the form of executable instructions stored on a machine-readable medium or in the form of electronic circuitry. A processor, a machine-readable storage medium, other control logic, or a combination thereof can be used to execute method 400.

Method 400 may start at 410 where an emotional state of a user is initialized. For example, the emotional state may be initialized at the beginning of a computing session between a user and a computer. A computing session may be defined in various ways, such as spanning across an entire day or only across a period of active use of the computer. Alternatively, a computing session may be defined as beginning any time the computer is powered on.

The tracked emotional state may be initialized in various ways. For instance, the tracked emotional state may be initialized at an average value representing a stable emotional state. For example, if a range for a standard emotional state is set between 5 and 15, a value of 10 may be selected for the initial emotional state. Alternatively, the tracked emotional state can be initiated based on responses from the user to one or more questions presented to the user inquiring into his current emotional state. For instance, user interface 240 of computing device 200 may be used to pose questions to the user.

In addition or alternatively, the initial emotional state of the user may be determined based on readings from one or more biometric sensors, such as a heart rate monitor, a galvanic skin response monitor, a voice tone analyzer, and a pupil movement tracker. Other biometric sensors may be used as well. In an embodiment, readings from the one or more biometric sensors may be further used to verify and/or correct the tracked emotional state after initialization. Sensor fusion techniques, such as employing a Kalman filter, can be used to integrate the readings from the biometric sensors into the tracked emotional state. Alternatively, the previously tracked emotional state can be discarded and the emotional state can be reinitiated based on the values from the one or more biometric sensors, based on the user's answers to questions, or the like.

The initial emotional state may also be determined by taking other environmental conditions into consideration, such as the time of day, stock market trends, the weather forecast, and the current season. A user profile, such as an emotional profile of the user, may also be accessed to determine an initial emotional state. A combination of these techniques may also be used.

Method 400 may proceed to 420 where the emotional stare is compared to a range. Computing device 200 can make the comparison using controller 220. Using the example above, a range of 5 to 15 can be used. The range may represent an emotional state that method 400 is attempting to maintain for the user. For example, the range may represent a stable, content emotional state. For instance, the one-dimensional emotional state as described above with reference to FIG. 1 represents a user's emotional state along the spectrum of positive to negative. A value of zero can be considered neutral, a value below zero can be considered negative, and a value above zero can be considered positive. In this example, a value between 5 and 15 is considered a stable, content emotional state (i.e., this example assumes that a stable, content emotional state should be at least a little positive along the positive-negative spectrum).

If the emotional state is within the range (NO at 420), method 400 may proceed to 430 where it waits for a user action (at 460) or for initiation of an object (at 470). Waiting may be an active or passive process of computing device 200. In some embodiments, method 400 can be implemented such that 430 is an end state for the method. Of course, the current value of the emotional state would need to be preserved (e.g., by storing it in a designated memory location). Then, user action (at 460) or initiation of an object (at 470), as described below, could invoke method 400 and cause continued processing within method 400.

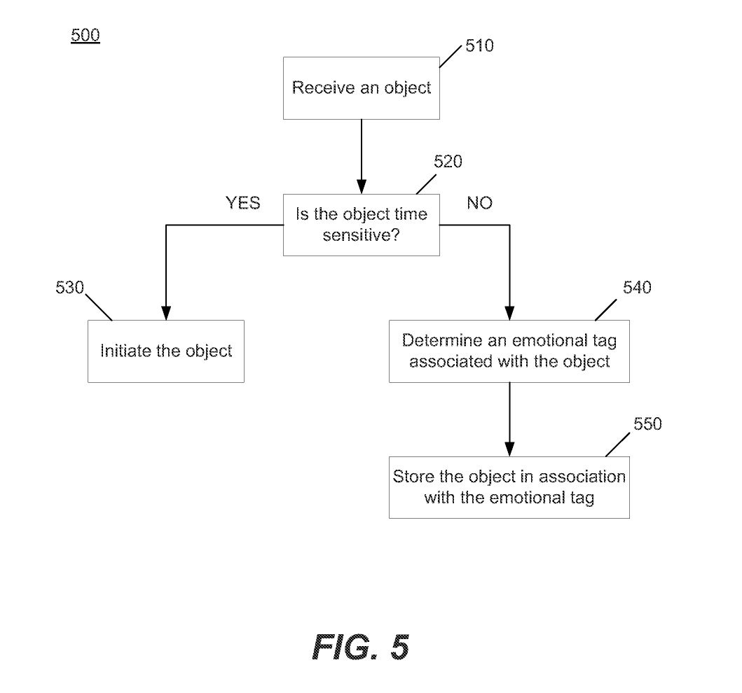

If the emotional state is not within the range (YES at 420), method 400 may proceed to 440 where it searches for a balancing object. A balancing object may be considered to be an object having a predicted emotional impact that will cause the tracked emotional state of the user to move closer to the range. In other words, the balancing object can help to rebalance the tracked emotional state. Computing device 200 can search for a balancing object using emotional state response module 226 of controller 220. A database of objects that can be searched is described below with respect to FIGS. 5 and 6, according to an example. At 450, a balancing object located at 440 can be suggested to the user.

The user may then accept or reject the balancing object at 460. If the user rejects the balancing object, method 400 may proceed to 430 to wait for another user action or the initiation of a different object. If the user accepts the balancing object, method 400 may proceed to 470 where the balancing object is initiated. In some embodiments, the balancing object can be automatically initiated and the user can cancel the balancing object if he is not interested. Interaction with the user may be achieved using user interface 240 of computing device 200.

At 470, the balancing object can be initiated. As described above, initiation of the balancing object can involve presenting the object to the user. For example, computing device 200 may present the object to the user via content presenter 210.

At 480, an emotional tag associated with the balancing object can be determined. Computing device 200 can determine the emotional tag using emotional impact determination module 222 of controller 220. Determining the emotional tag can simply mean accessing the associated emotional tag of the object from a database. For example, in the case of balancing objects, the emotional tag is already in existence since the balancing object was selected based on the expected emotional impact of the balancing object. However, if the object is not a balancing object but is a newly received object, as described below with respect to FIG. 5, an emotional tag may need to be created.

At 490, the emotional state may then be modified based on the emotional tag associated with the balancing object. Accordingly, the emotional state may reflect the predicted emotional impact of the newly initiated balancing object. Computing device 200 may modify the emotional state using emotional state modification module 224 of controller 220. Method 400 may then continue to 420 to check again whether the emotional state is outside the range.

Method 400 may receive inputs or be invoked at 460 and 470. For example, a user may take an action, such as requesting initiation of an object, at any moment. This is indicated by the feedback loop at 460. When the user requests initiation of an object (e.g., an email, a song, a website), method 400 may proceed to 470 where the object is initiated. Processing along method 400 may then proceed to 480, as described above. Additionally, certain objects may be automatically initiated. For example, an event, such as a calendar reminder, may be automatically triggered. This is indicated by the arrow from 530 of method 500, which enters method 400 at 470. Similar to a user request for initiation of an object, the object can be initiated at 470 and method 400 may proceed to 480, as described above.

FIG. 5 is a flowchart illustrating aspects of a method 500 that can be executed by a computing device for processing an object, according to an example. Although execution of method 500 is described below with reference to the components of computing device 200, other suitable components for execution of method 500 can be used, such as components of computing device 100 or computer 700. Method 500 may be implemented in the form of executable instructions stored on a machine-readable medium or in the form of electronic circuitry. A processor, a machine-readable storage medium, other control logic, or a combination thereof can be used to execute method 500.

Method 500 may start at 510 where an object is received. Computing device 200 can receive the object via communication interface 210. Alternatively, the object may be received from within computing device 200 (e.g., an error message from an application program). The object can be received from numerous sources. For example, the object can be a new content item, such as a communication, media item, event, or the like. For instance, the object can be a calendar reminder or new content from a news feed or RSS reader that the user has subscribed to.

At 520, it can be determined whether the object is time sensitive. Certain types of objects may be classified as time sensitive while other types of objects may be classified as time insensitive. For example, objects that are communications, such as an email, an instant message, a phone call, and a video call, can be categorized as time sensitive. On the other hand, media items such as a news feed or a newly downloaded song can be categorized as time insensitive. Alternatively, the objects may be categorized as time sensitive based on some other criteria. Computing device 200 can determine time sensitivity of an object using controller 220.

If the object is time sensitive (YES at 520), method 500 may proceed to 530 where the object is initiated. Method 500 may thus lead to 470 of method 400. In some embodiments; method 500 may not automatically initiate the object and may simply allow the user to initiate the object of his own accord. Thus, for example, a received email may simply go to the user's inbox where it may eventually be opened by the user.

If the object is time insensitive (NO at 520), method 500 may proceed to 540 where an emotional tag associated with the object may be determined. Since the object is new, it likely will not have an emotional tag already associated with it and a new emotional tag can be created. Computing device 200 can determine the emotional tag using emotional impact determination module 222 of controller 220. Creation of an emotional tag is described below in more detail with respect to FIG. 6.

After the emotional tag has been determined, the object may be stored in association with its emotional tag. For example, the object and emotional tag may be stored in a database. The database can be a database for storing time insensitive objects to be used to influence the emotional state of the user. Of course, the object may still be accessible to the user if he so desires. For example, a news story received from an RSS reader may still be accessed by the user by opening the RSS reader application.

FIG. 6 is a flowchart illustrating aspects of a method 600 that can be executed by a computing device for creating an emotional tag for an object, according to an example. Although execution of method 600 is described below with reference to the components of computing device 200, other suitable components for execution of method 600 can be used, such as components of computing device 100 or computer 700. Method 600 may be implemented in the form of executable instructions stored on a machine-readable medium or in the form of electronic circuitry. A processor, a machine-readable storage medium, other control logic, or a combination thereof can be used to execute method 600.

An emotional tag for an object can be created using method 600. Method 600 illustrates three ways in which an object can be evaluated to determine an appropriate emotional tag for the object. The results of the three processes may be combined to arrive at the emotional tag. In some embodiments, the emotional tag can be determined using only one of these ways, or a subcombination of them. Other ways of evaluating an object for predicted emotional impact may be used as well. Computing device 200 may execute method 600 using controller 220, and in particular emotional impact determination module 222.

Method 600 can start at 610 where a new object arrives. The object can be parsed at 620. Words in the object can then be compared with keywords at 622 to determine the keywords that are present in the object. The keywords that the words of the object are compared to can be stored in a database in association with an affective meaning or predicted emotional impact. Accordingly, at 624, a first tag value can be determined based on the predicted emotional impact of the keywords. In one example, the predicted emotional impact of the keywords may be averaged together to determine the first tag value.

Method 600 may also proceed to 630 where a search is performed for related objects. Related objects are objects that relate in some manner to the object being evaluated. Objects can be related in many ways. For example, an email may be related to other emails in the same chain or conversation. An email may also be related to the person that sent the email. The person may be represented as a contact, which is another kind of object that can have an associated emotional tag. A photo object may likewise be related to the people appearing in the photo. Accordingly, a web of related objects can be built. At 632, a second tag value can be determined based on the emotional tags associated with the related objects. In one example, all of the emotional tags of the related objects may be averaged together to yield the second tag value.

Method 600 may additionally proceed to 640 where a search for identical objects on other accessible devices is performed. An identical object is the same object on another device. For example, coworkers or friends may have one or more identical objects, such as the same emails, the same calendar events, the same media items, etc. These identical objects may have associated emotional tags. This may occur, for example, if the coworker or friend's computing device has already processed the identical object. In addition, identical objects can be searched for on one or more servers. For example, a server may house a large number of a particular type of content items, such as songs, images, or the like, with associated emotional tags. The emotional tags may indicate a typical emotional impact of the content items on an average person. At 642, a third tag value can be determined based on the emotional tags of the identical objects. In one example, all of the emotional tags of the identical objects may be averaged together to yield the third tag value.

Method 600 may then proceed to 650 where a final tag value can be determined based on the first, second, and third tag values. In one example, the first, second, and third tag values may be averaged together to yield the final tag value. The final tag value can be the emotional tag of the object. If the object has already been initiated, the emotional tag can be used to modify the tracked emotional state of the user. If the object has not yet been initiated, the emotional tag can be stored in association with the object for later use.

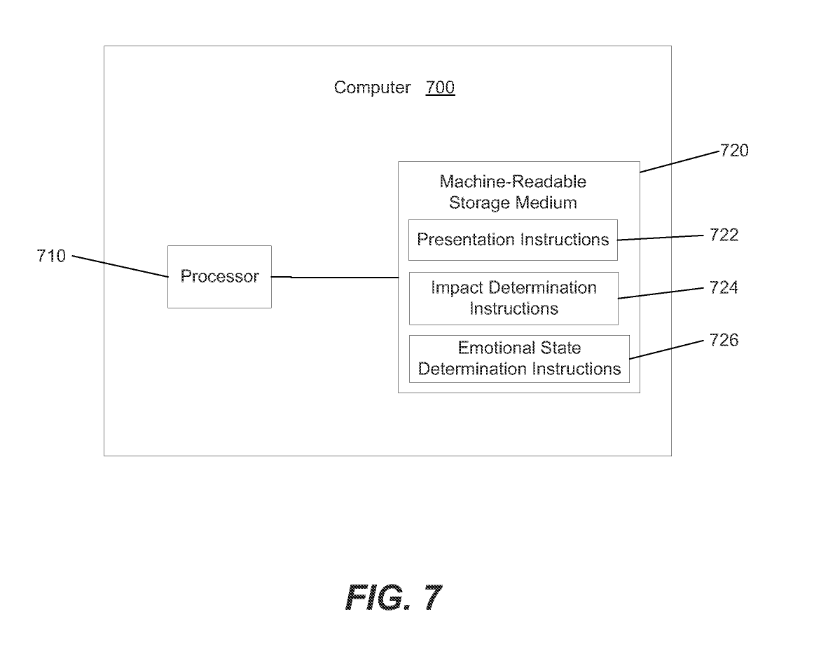

FIG. 7 is a block diagram illustrating aspects of a computer 700 including a machine-readable storage medium 720 encoded with instructions to determine a user's emotional state, according to an example. Computer 700 may be any of a variety of computing devices, such as a cellular telephone, a smart phone, a media player, a tablet or slate computer, a laptop computer, or a desktop computer, among others.

Processor 710 may be at least one central processing unit (CPU), at least one semiconductor-based microprocessor, at least one digital signal processor (DSP) such as a digital image processing unit, other hardware devices or processing elements suitable to retrieve and execute instructions stored in machine-readable storage medium 720, or combinations thereof. Processor 710 can include single or multiple cores on a chip, multiple cores across multiple chips, multiple cores across multiple devices, or combinations thereof. Processor 710 may fetch, decode, and execute instructions 722, 724, 726, among others, to implement various processing. As an alternative or in addition to retrieving and executing instructions, processor 710 may include at least one integrated circuit (IC), other control logic, other electronic circuits, or combinations thereof that include a number of electronic components for performing the functionality of instructions 722, 724, 726. Accordingly, processor 710 may be implemented across multiple processing units and instructions 722, 724, 726 may be implemented by different processing units in different areas of computer 700.

Machine-readable storage medium 720 may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium 720 can be computer-readable and non-transitory. Machine-readable storage medium 720 may be encoded with a series of executable instructions for presenting content items, determining expected emotional impact of the content items, and determining an emotional state of a user.

The instructions 722, 724, 726, when executed by processor 710 (e.g., via one processing element or multiple processing elements of the processor) can cause processor 710 to perform processes, for example, the processes depicted in FIGS. 3-6. Furthermore, computer 700 may be similar to computing device 100 or computing device 200 and may have similar functionality and be used in similar ways, as described above.

Presentation instructions 722 can cause processor 710 to present an email to a user via a display of computer 700. The email may be displayed using an application program, such as a stand-alone email application like Microsoft® Outlook® or a web-based email application like Gmail®. The email may have been recently received by computer 700. In some embodiments, presentation instructions 722 can cause processor 710 to present the email to the user via another device or in another manner, such as by presenting the email via a speaker using a speech synthesis program.

Impact determination instructions 724 can cause processor 710 to determine an expected impact of the presented email on an emotional state of the user. The expected impact can be a predicted emotional impact of the email determined by using the techniques described above for determining likely emotional impact of a content item. For example, the expected impact can be determined based on keywords present in the email, a person associated with the email, or other content items associated with the email.

Emotional state determination instructions 726 can cause processor 710 to determine the emotional state of the user based on the expected impact of the email. In particular, computer 700 can track an emotional state of the user and emotional state determination instructions 726 can determine a current emotional state of the user by modifying the tracked emotional state of the user based on the expected impact of the presented email. Thus, the tracked emotional state can reflect an impact that the email is expected to have on the user's emotional state.

Presentation instructions 722 can cause processor 710 to present a media item to the user if the determined emotional state is outside a range. The range can represent an emotional state that computer 700 is attempting to maintain for the user. For example, the range may represent a stable, content emotional state. Thus, if the user's emotional state is determined to be outside of the range, computer 700 can take an action to attempt to cause the determined emotional state to move back into the desired range. For example, the media item can be presented to the user in an attempt to bring the user's emotional state back within the range. Thus, the media item can have an expected impact on the emotional state of the user that is opposite to the expected impact of the email. For instance, if the presented email had an expected negative effect on the user's emotional state due to the inclusion of inflammatory language, the media item presented to the user can be selected because it has an expected positive effect on the user's emotional state.

The media item can be any of various media items. For example, the media item can be a background color, an image, a video, a news story, a song, a document, or the like. In some embodiments, a different kind of content item can be presented instead of a media item.

Emotional state determination instructions 726 can cause processor 710 to modify the emotional state of the user based on the expected impact of the media item. Thus, the tracked emotional state of the user can reflect all presented content items.

In some embodiments, if the emotional state of the user is still outside of the desired range, another media item or other content item can be selected to attempt to bring the emotional state back within the range. For example, additional content items may be continually presented to the user until the emotional state is back within the range. Alternatively, instead of looking at the expected impact of a received email and choosing a media item with an opposite impact, the media item can be selected by determining whether the current emotional state is above or below the desired range and selecting a media item having an expected impact that would cause the emotional state to move toward the desired range.

What is claimed is:

1. A computing device comprising;
a content presenter to present content items to a user of the computing device; and
a controller to determine a current emotional state of the user based on a predicted emotional impact of each of the presented content items.

2. The computing device of claim 1, wherein the controller comprises:
an emotional impact determination module to determine the predicted emotional impact of each presented content item; and
an emotional state modification module to determine the current emotional state of the user by modifying a tracked emotional state of the user based on the predicted emotional impact of each presented content item.

3. The computing device of claim 2, wherein the emotional impact determination module is configured to determine a predicted emotional impact of a presented content item based on a keyword associated with the presented content item.

4. The computing device of claim 2, wherein the emotional impact determination module is configured to determine a predicted emotional impact of a presented content item based on a person associated with the presented content item.

5. The computing device of claim 2, wherein the controller further comprises:
an emotional state response module to select a balancing content item if the current emotional state is outside a range and cause the content presenter to present the selected balancing content item to the user.

6. The computing device of claim 5, wherein the emotional state response module is configured to select the balancing content item based on a predicted emotional impact of the balancing content item, such that the current emotional state moves closer to the range when the emotional state modification module modifies the tracked emotional state based on the predicted emotional impact of the balancing content item.

7. The computing device of claim 5, further comprising:
a first user interface to receive from the user a response to a question regarding a current emotional state of the user; and
a second user interface to receive from the user a response indicating acceptance or rejection of the balancing content item,
wherein the emotional state modification module is configured to modify the tracked emotional state of the user based on a response received via the first or second user interface.

8. A method, comprising:
initiating a first object on a computing device;
determining an emotional tag associated with the first object, the emotional tag indicating a predicted emotional impact of the first object on a user of the computing device;
determining an emotional state of the user of the computing device based on the emotional tag associated with the first object; and
initiating a second object if the emotional state is outside of a range.

9. The method of claim 8, further comprising:
modifying the emotional state of the user based on an emotional tag associated with the second object, wherein the emotional tag associated with the second object causes the emotional state of the user to move closer to the range.

10. The method of claim 8, wherein determining an emotional tag associated with the first object comprises accessing the emotional tag from a database where the emotional tag is stored in association with the first object.

11. The method of claim 8, wherein determining an emotional tag associated with the first object comprises creating the emotional tag based on at least one of a keyword associated with the first object, an emotional tag associated with an object related to the first object, and an emotional tag associated with an object identical to the first object.

12. The method of claim 8, further comprising:
receiving an object;
categorizing the object as time sensitive or time insensitive;
if the object is categorized as time sensitive, initiating the object; and
if the object is categorized as time insensitive,
determining an emotional tag associated with the object, and
storing the object in association with the emotional tag in a memory designated for objects used to influence an emotional state determined to be outside the range.

13. The method of claim 8, further comprising:
modifying the emotional state of the user based on a measured value from a biometric sensor associated with the user.

14. A non-transitory machine-readable storage medium encoded with instructions executable by a processor of a computer, the machine-readable medium comprising:
instructions to present an email to a user via a display of the computer;
instructions to determine an expected impact of the email on an emotional state of the user;
instructions to determine the emotional state of the user based on the expected impact of the email; and
instructions to present a media item to the user if the determined emotional state is outside a range, the media item having an expected impact on the emotional state of the user that is opposite to the expected impact of the email.

15. The machine-readable medium of claim 14, further comprising:
instructions to modify the determined emotional state of the user based on the expected impact of the media item.
